(19) United States
(12) Patent Application Publication
(10) Pub. No.: US 2013/0327915 A1
(43) Pub. Date: Dec. 12, 2013

(54) ShowMeStand TM

(71) Applicant: Michael William O'Neal, Tallahassee, FL (US)

(72) Inventor: Michael William O'Neal, Tallahassee, FL (US)

(21) Appl. No.: 13/494,197

(22) Filed: Jun. 12, 2012

(51) Int. Cl. F16M 11/00

(52) U.S. Cl. CPC F16M 11/00
USPC 248/545

(57) ABSTRACT

The ShowMeStand™ ground mounted portable sign support consists of five assemblies (Two assemblies in the current version as (1) (2) (3) and (4) are one piece solid construction; (5) insert sleeve is not needed with current version and is eliminated and the second assembly is the (6) clamp; (1) is a support tube mounted to an anchor, consisting of a rod (2) with a triangular soil plate (3) and circular washer plate (4); the washer plate (4) attaches to the top of the triangular soil plate (3) and rod anchor (2); a smaller tube insert (sleeve) (5) fits over the anchor rod (2) and inside the main support tube (1); in the current version as (1) (2) (3) and (4) are one piece solid construction and (5) insert is not used; a clamp (6) wraps around the main support tube (1) with a thru bolt permanently attached to the clamp. Said clamp (6) temporarily attaches a rib crossbrace to the stand to support a roll-up style (vinyl or mesh material) sign. A pipe driver fits over the main support tube (1) for ground mounting the sign stand; (THE DRIVER IS NOT INCLUDED AS PART OF THIS INVENTION); the drivers main tube (7) and smaller tube insert (sleeve) (8) keeps the driver aligned over the sign stand support tube (1); (THE DRIVER insert sleeve IS NOT INCLUDED AS PART OF THIS INVENTION)

### FIELD OF THE INVENTION

The present invention relates generally to posts for holding up signs, signal flags and the like used in roadway work zones. More particularly, it is an improved support system for work zone signs that is extremely durable, portable, easy to use, compact and relatively lightweight. It is able to withstand the extra wind forces generated by traffic along roadways and the rigors of ground mount/dismount, yet remain in compliance with Federal Highway Administration (FHWA) acceptance as a crashworthy traffic control device for use in work zones on the National Highway System (NHS).

### DESCRIPTION OF THE PRIOR ART

There have been numerous structures and devices designed to be utilized along public roadways to provide information and mark limits of work zones, etc. Often it is necessary for these signs to be temporary and portable in nature such as those used by survey or utility crews (with mobile work zones) relocating along a roadway often, even hourly on occasion. The prior art sign support structures have many disadvantages of these type of work crews as they are often bulky, cumbersome and heavy, or, at the opposite end of the spectrum, so lightweight in their Construction or choice of materials their longevity is quite short when put thru the rigors of everyday use. Many of the prior art structures do not meet current (FHWA) crashworthy acceptance. The improvements to prior art sign stands incorporated into the invention of the ShowMeSatnd were concentrated on ease of use, lighter weight, and simplicity yielded surprising and unexpected results as by eliminated the majority height of the main mast or support tube and thru bolt clamping the display (sign) ribs to the ShowMeStand support tube were in fact the improvements which enabled ShowMeStand to pass current FHWA crashworthy requirements (no damage to or penetration of windshields). Some of these devices are shown in U.S. Pat. Nos.: 4,490,934; 4,694,601; 4,426,800; 4,019,271; 4,378,650; 4,658,534; 4,662,305; 5,438,782; 7,444,774 and 7,628,373.

The commonly used sign for these work zone stands have evolved and improved over time to flexible panels which can be rolled up for better storage and transport. The most commonly used sign of this type is supported and stretched flat with a pair of lightweight flexible ribs (crossbraces) of molded fiber material. The two ribs are typically connected and pivot at center so when extended, form a cross to support the flexible sign similar to a kite.

Much of the prior art for support stands to be used in roadway work zones are designed to utilize these roll-up style signs and flexible ribs. The prior art varies greatly as to the size and construction of the stands as well as method used for attaching the sign to the stand. They all however have direct structural support or mast arms running the majority of the height of the displayed sign. Many utilized clamps only to attach the displays to the sign stand, often an Achilles heel in high speed crashworthy tests required by the FHWA in recent years.

### SUMMARY OF THE INVENTION

The present invention ShowMeStand™ represents a much improved system for support of roll-up signs. It is a relatively simple design (when compared to most work zone sign stands currently available) that started with use of sign stands in this inventors' profession of Land Surveying. This inventor built stands for personal use and testing to specifications of a non-patented plan that was submitted to the Federal Highway Administration (FHWA) for acceptance as a crashworthy traffic control device for use in work zones on the National Highway System with crash test results by the Missouri Roadside Safety Facility, Lincoln, Nebr. Said plan received crashworthy acceptance by the (FHWA) with acceptance letter designated as (WZ-219). The present invention is a much improved system over that represented in said (WZ-219) and this improved present invention has been analyzed for crashworthiness and submitted for acceptance to the (FHWA). The present invention is also similar to that of U.S. Pat. No. 4,662,305 in that it is ground mounted with a rod anchor system and has fin like soil plates for wind stability. The similarity ends as the ShowMeStand is a vastly improvement over these with less than half the height of the main support tube for safety and reduced storage. Larger single soil plate vs. multiple smaller plates for stability in high winds; no hammering device built in to the ShowMeStand as with U.S. Pat. No. 4,662,305 which greatly reduces weight and handling requirements.

The present invention is a significant improvement over the aforementioned designs. The present invention is approximately half the length and weight of the stand in U.S. Pat. No. 4,662,305. In crash tests submitted to the (FHWA) the stand in U.S. Pat. No. 4,662,305 struck the windshield of the test vehicle as noted in (FHWA) letter (WZ-64). The triangular (soil plate) (3) attached to the (anchor rod) (2) and the rod itself form the ground anchor are both significantly larger on the present invention than on that of U.S. Pat. No. 4,662,305, giving the present invention greater stability with wind forces. Having a larger diameter (anchor rod) (2) also gives the present invention increased longevity as the anchor rod tends to bend and weaken with rigorous use in hard ground, as well as bending with lateral pull and impact blows by crews in the process of removing the sign stands in hard ground. The latest version of the ShowMeStand is a one piece product of an extremely hard high strength material blended to form the entire stand assembly as one piece (1), (2), (3) and (4).

Additionally, the lesser diameter anchor rods become bent during storage and transport. This bending and weakening is also a common issue with sign stands constructed of simple steel angle iron, in addition to their failure to receive high speed crashworthy acceptance from the (FHWA). Unlike either of the ground mounted stands cited. The stand submitted to the (FHWA) in WZ-219 called for a specific “Telespar” brand steel square tubing for the (main/single support tube). The “Telespar” tubing is not a readily available item and is deemed to be significantly weaker in construction than the two piece solid tubing utilized with the present invention. The “Telespar” has holes, perforated on all sides at an approximate 1″ interval. The perforated “Telespar” is commonly used on larger work zone sign stands for use above ground and typically of a more permanent nature such as during construction. Utilizing a two stage/two piece solid tubing for the main support instead of the single piece “Telespar” tube, the stability and longevity of the present invention is greatly increased. The latest version of the ShowMeStand is a one piece product of an extremely hard high strength material blended to form the entire stand assembly as one piece (1), (2), (3) and (4). The clamp with thru bolt is separate, so technically this is a two piece product as the clamp (6) is separate. (5) insert sleeve is not needed with the current version one piece stand assembly.

The stand built by specifications in (WZ-219) was found to have a short lifespan as the welds for the attachment of the main support tube fail after repeated (daily) use in hard soils as typically found in roadway work zones. The Inventor realized the best method of driving the stands built per (WZ-219) specifications was to utilize a length of larger diameter heavy steel pipe as a driver over the support tube (1) that impacts the (washer) (4). Over time (typically within six months of daily use) the weld connecting the main single support tube (1) to the washer (4) and/or the main support tube itself would fail due to a combination of impact vibration during driving and from stress caused during removal from back and forth lateral pulling (tugging) of the stand to remove from hard ground. These factors are eliminated with either version of the current invention. All weld issues and manufacturing/assembly processes are eliminated with the current one piece stand assembly version with (1), (2); (3) and (4) as one solid piece construction.

The present invention adds stability and strength to the entire assembly by utilizing a two piece/two stage (solid) support tube consisting of a short length of smaller size solid tube (sleeve) (5) inserted in the bottom portion of the main support tube (1) and tightly fitting as a sleeve over the anchor rod (2). This insert (5) is welded directly to both the main support tube (1) and the anchor rod (2), effectively forming a solid object via welds. When this design of a (solid) support system is added to the single weld of the main support tube (1) with the anchor washer (4) as found on the stand built by specifications in (WZ-219) the overall strength of the stand is greatly improved. The additional (sleeve) (5) provides a solid fit between the anchor rod (2), main support tube (1) and the remaining components of the sign stand, washer (4) and triangular plate (3). This “solidification” at the bottom of the Inventors' sign stand support eliminates a significant amount of vibration between the main support tube (1) to anchor weld at the washer (4) that was common to the stand built by specifications in (WZ-219) and the cause for field failure of that stand in field use. Vibration damage to the weld connecting the main support tube (1) to the anchor is significantly reduced with the Inventors' addition of the solid support sleeve insert (5) inside the main support tube (1). The current version of the ShowMeStand eliminates all weld break issues of this and prior art as it is a single one piece solid object of composite fiber type material. The support sleeve insert (5) is not utilized on the current version as the entire main support tube is solid and is one contiguous object as drawing numbers 1, 2, 3 and 4 are all one continuous solid object, formed without welds.

The Inventor custom designed the ShowMeStand Driver with an insert of a smaller size tube sleeve (8) inserted in and slightly recessed up from the bottom of the main driver tube. This insert (5) is slightly larger than the main support tube (1) of the sign stand and allows the driver to ride tightly over the main support tube (1) and suspend the bottom of the larger main driver tube outside of and clearing the weld on the anchor washer (4) and main support tube (1) of the one (welded) version of the sign stand when striking the anchor washer (4). The main tube (7) on the driver has a solid flat piece covering the top of the driver to prevent ones fingers or clothing from getting caught inside the driver between the driver and sign stand during the drive (ground) mount process. A solid bar handle or handle(s) may also be welded to the driver for convenience and ease of use. The driver is not part of the invention, but is merely listed and described here for explanation of the best, most efficient method of ground mounting the invention. The driver is used with both the older welded version of the ShowMeStand and the current one piece version.

The (clamp bolt assembly) (6) used to attach the vertical flexible rib of the roll-up signs to the main support tube (1) per the (WZ-219) specifications has also been modified. The bolt utilized and permanently attached/welded or formed into said clamp is deemed to be of primary importance in the crashworthiness of the stand as noted in the test results in the FHWA (WZ-219) letter.

The present invention utilizes a larger diameter bolt than specified in the (WZ-219) letter, which adds strength and longevity while also are of a size that accommodates readily available knobs such as those employed on lawnmower handle or faucet handle style nuts rather than using a common hexagonal nut that requires a wrench. The lawnmower or faucet style knobs significantly reduce crew time and effort in using the stand as well as protect the flexible vinyl or mesh fabric of the roll-up sign itself during storage as the clamp/bolt assembly (6) and knob stays with and is attached to the vertical sign rib during storage and transport. The present invention greatly improves the performance and useful life of the stand and the sign attachment clamp as further indicated in claims and depicted on attached drawings. This thru bolt design improvement prevents the sign display from becoming detached from the main support tube in a crash as proven in crash testing which prevents the display and support ribs and other attachments from striking, damaging and penetrating windshield. The display/sign falls down with and stays with the ShowMeStand when struck by the vehicle, rather than being flipped up into the air at windshield level with mast arms and displays of prior art.

### BRIEF DESCRIPTION OF THE DRAWINGS

FIG. 1: ShowMeStand™ ground mounted with sign (rear view) dimensions on sketch are relative to mounted heights of typical roll-up traffic sign (current version is One piece construction)

FIG. 2: ShowMeStand™ (no sign or crossbraces attached) (rear view) (current version is One piece construction)

FIG. 3: ShowMeStand™ (side view) (current version is One piece construction)

FIG. 4: ShowMeStand™ (top view without clamp) (current version is One piece construction)

FIG. 5: ShowMeStand™ Driver (bottom view without top/end cap) (NOT INCLUDED as part of this invention)

FIG. 6: ShowMeStand™ Driver (front view) (NOT INCLUDED as part of this invention)

FIG. 7: ShowMeStand™ (exploded component view) (current version is One piece construction)

FIG. 8: ShowMeStand™ Driver (exploded component view) (NOT INCLUDED as part of this invention)

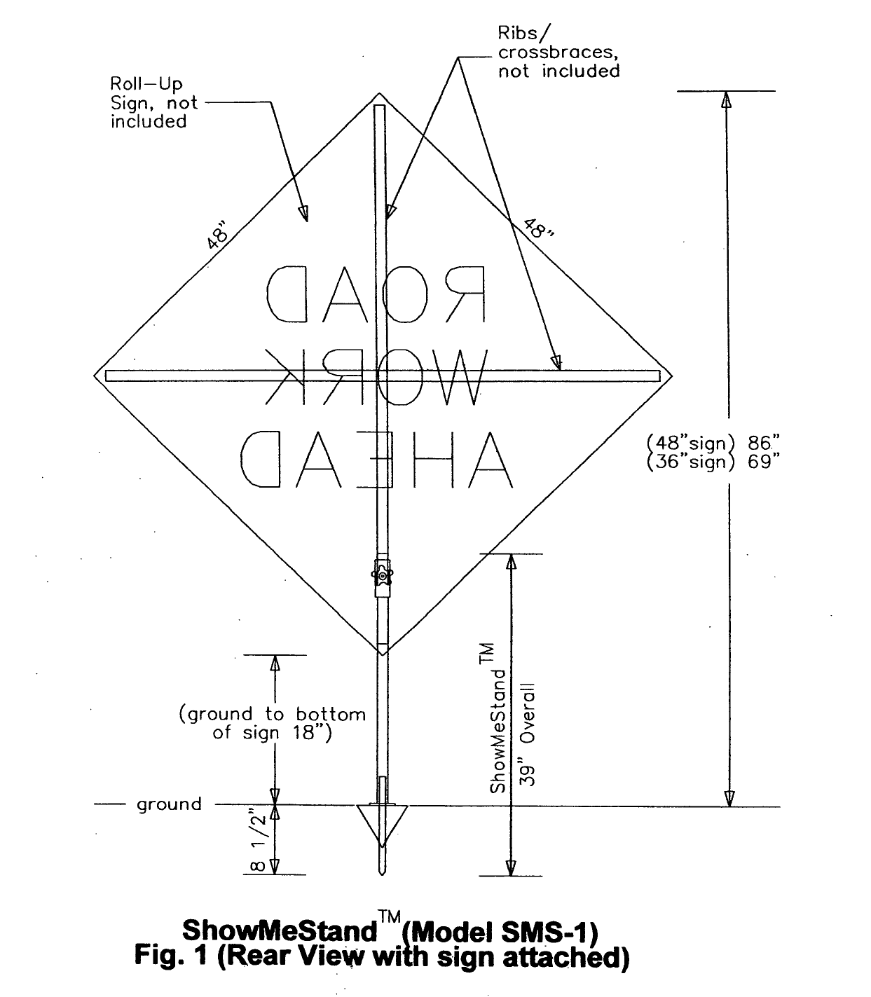

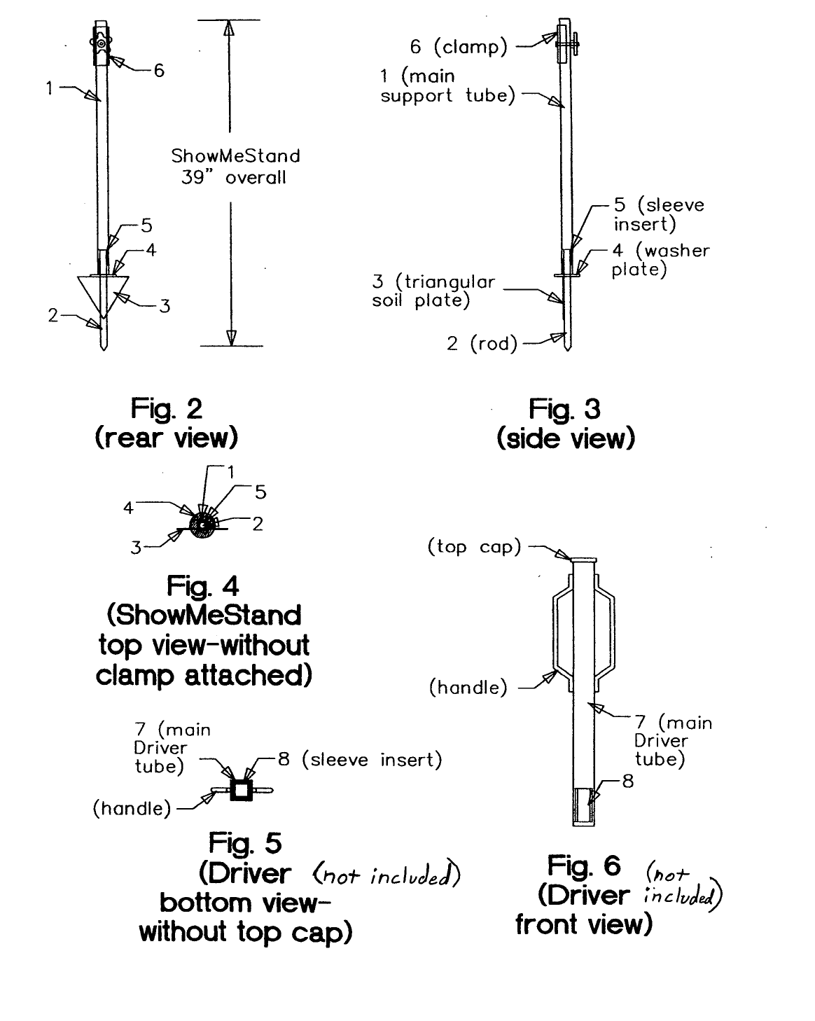

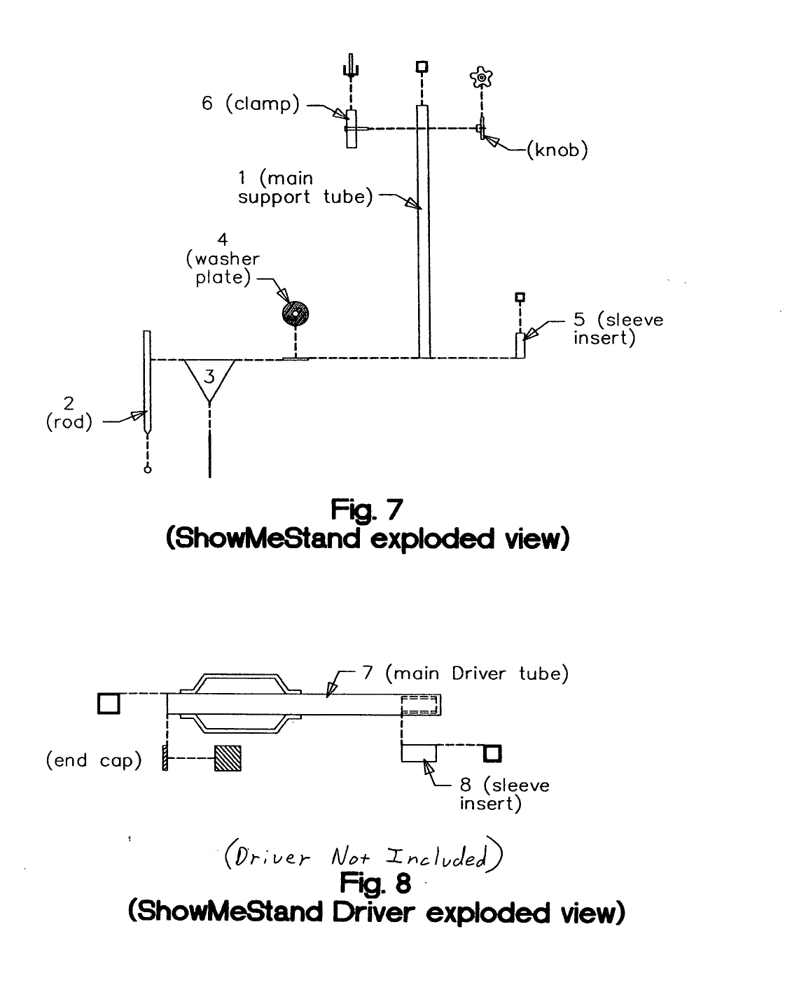

What is claimed:

1. A sign stand for supporting a display above ground, said sign stand improvement comprises:
An elongated support shaft main support tube (1) with solid wall construction (current version is solid one piece construction (1), (2), (3) and (4) including a means for ground penetration at one end thereof;
a lower flange washer (4) mounted at one end (ground level) bottom end of the main support tube (1) (current version is solid one piece construction (1), (2), (3) and (4);
a solid anchor rod (2) attached to the aforesaid and main support tube (1) as a means for ground penetration. Said solid anchor rod (2) is to be of a substantial diameter (current version is solid one piece construction (1), (2), (3) and (4);
a solid anchor rod (2) attached to the aforesaid washer (4) and main support tube (1) as a primary support for the overall stand and soil plate (3) below ground (current version is solid one piece construction (1), (2), (3) and (4);
an elongated support shaft sleeve (5) with solid wall construction, (1) (2) placed over the top of and attached to the solid anchor rod (2) below the washer (4) and placed inside and attached to the bottom of aforesaid main support tube (1) (current version is solid one piece construction (1), (2), (3) and (4);
a single solid triangular plate-soil plate (3) attached to the aforesaid solid anchor rod (2) also attached to and below washer (4), mounted parallel to the intended face of sign to allow wind sheer support for the sign stand (current version is solid one piece construction (1), (2), (3) and (4);
a clamp (6) attachment devise in a channel shape with a thru bolt mounted in a position to allow said thru bolt to penetrate the main support tube (1) and the vertical flexible rib of a sign at a certain position determined to be the most advantageous in crash tests and allow for the bottom of the sign to maintain a certain height above ground as required by the FHWA; the bolt used and permanently attached to said clamp is to be of a size to allow for the use of universal lawnmower or faucet style knob;
a custom (designed to fit) driver with a primary driver tube (7) being capped to provide user safety. (The Driver IS NOT PART OF THE CURRENT INVENTION)
a solid driver sleeve insert (8) inserted and attached at the bottom of the aforesaid main driver tube (7) and recessed slightly above the bottom edge of the main driver tube (7) to allow the main driver tube (7) to uniformly slide over the stand main support tube (1) thus allowing a safe, smooth uniform drive of the sign stand and prevents impact to the weld attaching the stand main support tube (1) to the washer (4) the current version is solid one piece construction (1), (2), (3) and (4) which eliminates all welds on the current invention (the driver sleeve is NOT PART OF THE CURRENT INVENTION)
